(19) United States
(12) Patent Application Publication
(10) Pub. No.: US 2018/0093649 A1
(43) Pub. Date: Apr. 5, 2018

(54) ELECTRONIC BRAKE VALVE CONTROLLER WITH ADJUSTABLE FRICTION AND DETENT TORQUE

(71) Applicant: NEW YORK AIR BRAKE,LLC, WATERTOWN, NY (US)

(72) Inventors: Erich Leonard, Clayton, NY (US); Peter Greetham, Cicero, NY (US); Steve Newton, Adams, NY (US)

(73) Assignee: NEW YORK AIR BRAKE, LLC, WATERTOWN, NY (US)

(21) Appl. No.: 15/285,673

(22) Filed: Oct. 5, 2016

(51) Int. Cl. B60T 7/10; G05G 1/04; G05G 5/00

(52) U.S. Cl. CPC B60T 7/102; G05G 2700/12; G05G 5/00; G05G 1/04

(57) ABSTRACT

A brake controller having independently adjustable friction and detent torque to allow for easy adjustment of handle feel without changing or replacing components. The brake handle is coupled to a cam that rotates with the handle and has a series of divots in its outer circumference corresponding to established brake handle positions. A detent roller is biased by an adjustable spring into engagement with the outer circumference of the cam and thus into the divots when the handle is moved. A separately adjustable spring biases a lateral surface of the cam into engagement with a frictional surface. Independent adjustment of the two spring can adjust both detent and friction torque, thus allowing a user to easily adjust handle feel without having to change or replace handle components

### BACKGROUND OF THE INVENTION

### 1. Field of the Invention

The present invention relates to electronic brake valves and, more specifically, to an electronic brake valve having independently adjustable friction and detent torque.

### 2. Description of the Related Art

An electronic brake valve (EBV) is the human interface for a computer controlled train braking system and includes a EBV controller having one or more handles that may be moved by the train operator to selectively apply and release the train brakes. The handles may be positioned in a number of predetermined locations that correspond to certain brake applications, e.g., brakes released, full service, or emergency service. The ease with which the handles of a brake controller are moved is referred to as “handle feel” and different railroads often have different preferences for EBV handle feel. Handle feel can be characterized by the amount of force (torque) needed to move the handle between detents (friction torque) and the amount of force needed to move the handle out of a detent (detent torque plus friction torque). The ratio of friction torque to detent torque determines how smoothly and precisely the handle can be moved out of a detent and into a friction zone. Currently, these two types of torque have a fixed ratio for a particular set of components. Thus, in order to set or adjust the amount of torque in a conventional EBV handle, the components must be specifically selected prior to assembly of the controller or replaced in an existing controller to achieve the desired handle feel. As handle torque may change over time due to wear, restoring the originally selected handle feel requires replacement of worn handle components. Accordingly, there is a need in the art for an EBV handle system that has a handle feel that can be easily adjusted, whether at assembly and installation, or at later date, without having to change or replace handle components.

### BRIEF SUMMARY OF THE INVENTION

The present invention is a brake controller having independently adjustable friction and detent torques and thus may be adjusted to have a desired handle feel without having to change components of the brake controller. The brake controller has a user handle rotatable into and between a series of predetermined positions, a cam associated with the user handle for rotation therewith, a first spring assembly providing a first biasing force resisting rotation of the cam, and a second spring assembly providing a second biasing force resisting rotation of the cam. The first spring assembly comprises a lever, a roller carried by the lever, and a first spring positioned to provide a first biasing force urging the roller into contact with the cam. The cam includes an outer circumference having a series of divots corresponding to the series of predetermined positions into which the roller may extend when the handle is rotated. A screw associated with the first spring that may be turned to increase or decrease compression of the first spring. The second spring assembly comprises a second spring positioned to provide a second biasing force urging a lateral surface of the cam into a frictional surface. The second spring includes a spring cup that may be rotated to increase or decrease compression of the second spring.

According to the present invention, a brake controller may be adjusted to a desired handle feel by independently adjusting the friction and detect torques of a brake controller. The method of adjusting the handle feel of the brake controller includes changing the detent torque by changing the compression of a first spring that provides a first biasing force resisting the rotation of a cam that is interconnected to and rotatable with a user handle of the brake controller. The first spring preferably urges a roller into engagement with the outer circumference of the cam, which includes a series of divots corresponding to conventional brake handle positions. The friction torque is then adjusted by changing the compression of a second spring that provides a second biasing force resisting the rotation of the cam. The second spring preferably urges a lateral side of the cam into engagement with a frictional surface.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a perspective view of an electronic brake valve controller according to the present invention;

FIG. 2 is an exploded view of a controller frame and adjustable torque handles for an electronic brake valve controller according to the present invention; and

FIG. 3 is an exploded view of an adjustable torque handle for a brake valve controller according to the present invention.

### DETAILED DESCRIPTION OF THE INVENTION

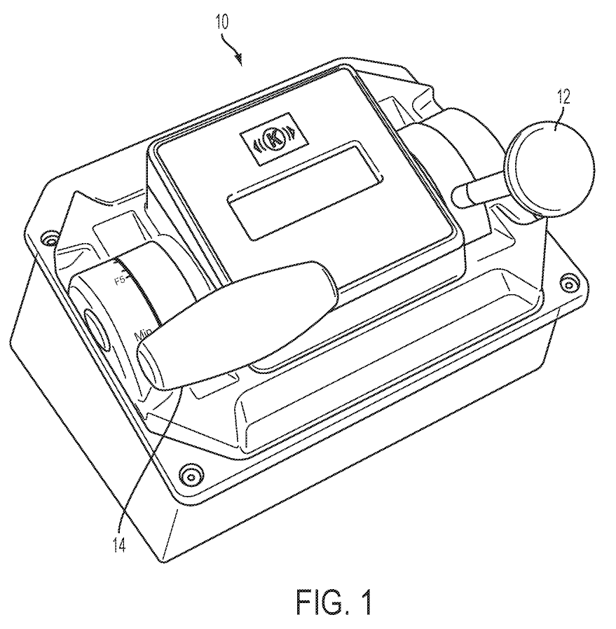

Referring to the figures, wherein like numerals refer to like parts throughout, there is seen in FIG. 1 an adjustable torque EBV controller 10 according to the present invention. EBV controller 10 has a pair of handles 12 and 14 for use by a train operator in controlling the locomotive and rail car braking system of a train. As is known in the art, the positions of the handles are translated into the appropriate braking system commands by controller 10 and communicated to the braking system of the train.

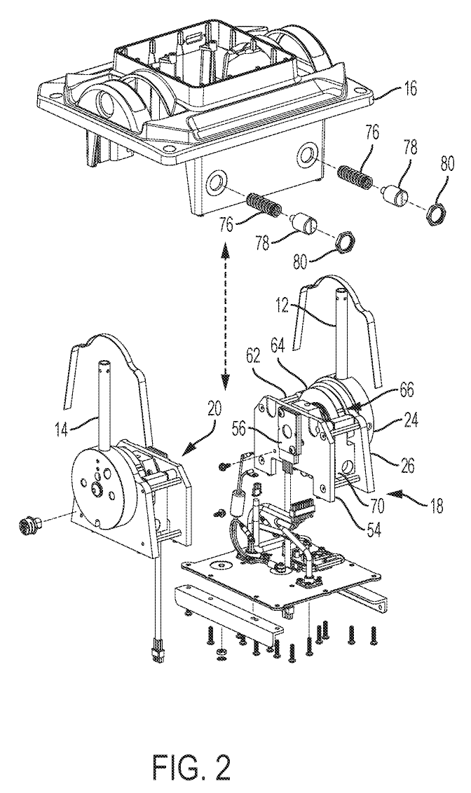

Referring to FIG. 2, controller 10 includes a central frame 16 that supports a pair of handle assemblies 18 and 20 and encloses the necessary electronics for determining handle positions and communicating with the braking system of a train. As described below, each handle assembly 18 and 20 may allow for independent adjustment of both friction and detent torque so that controller 10 can be adjusted to meet the needs of a particular user. The adjustment may be performed at the time of installation or in the future if normal wear and tear changes the handle feel of the controller.

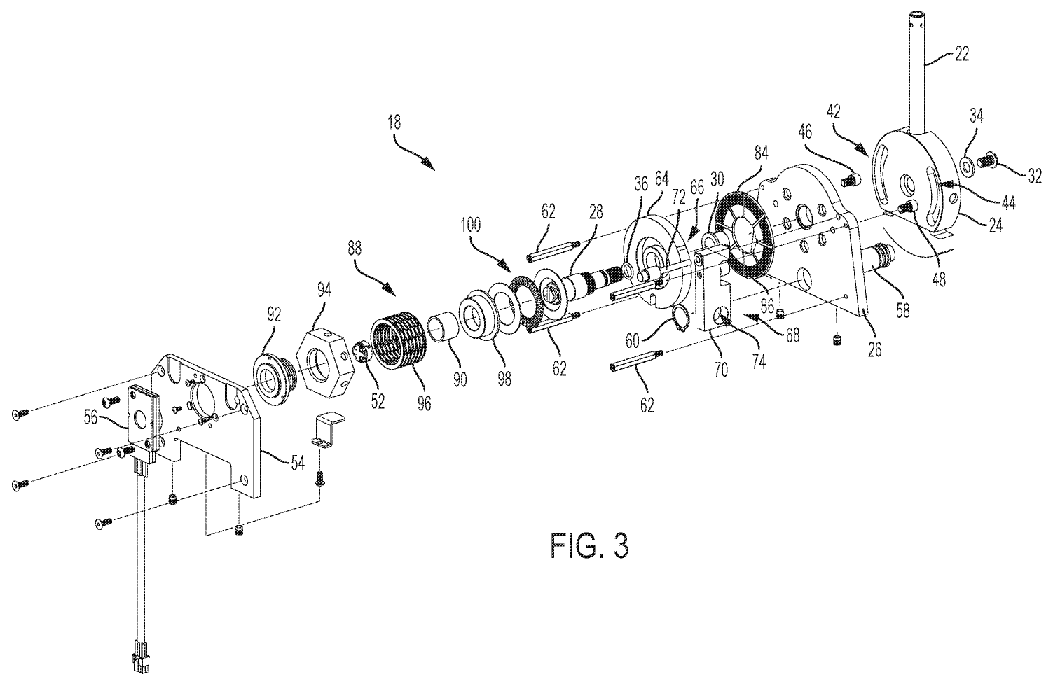

Referring to FIG. 3, each handle assembly 18 comprises a handle 22 having a base 24 that is pivotally mounted alongside an outer plate 26 and fixedly attached to a main shaft 28 that extends through a bushing 30 positioned in outer plate 26. Shaft 28 is held in place by a screw 32, washer 34, and O-ring 36 that engage handle base 24. Handle base 24 includes a pair of arcuate slots 42 and 44 formed therethrough that accept a pair of stops 46 and 48 that are mounted to and extend outwardly from outer plate 26. The other end of shaft 28 includes a magnetic cap 52 that extends through an inner plate 54 positioned in parallel with outer plate 26. Magnetic cap 52 interfaces with a sensor 56 that determines the position of shaft 28 based on magnetic cap 52, and thus the position of handle 18, so that the braking system can be commanded to produce whatever braking state is indicated by the position of handle 22. Inner plate 54 is spaced apart from outer plate 26 by a plurality of standoffs 62. Outer plate 26 may also support a switch cam assembly 58 held in place by a retaining ring 60 for providing an electrical connection point or external connector receptacle.

A cam 64 is fixedly attached to shaft 28 on the opposing side of outer plate 26 from handle 22 for co-rotation with handle 22. Cam 64 includes a series of divots 66 formed in its outer circumference that correspond to the established industry brake handle positions, e.g., full service, emergency service, etc. A first spring assembly 68 provides a biasing force against the outer circumference of cam 64 that resists rotation of cam 64. Spring assembly 68 includes a pivoting lever 70 having a detent roller 72 is positioned so that detent roller 72 engages the outer circumference of cam 64 and is biased to fall into divots 66 when rotated by handle 22 into proximity therewith. Lever 70 includes a recess 74 for housing a detent spring 76, seen in FIG. 2, which urges detent roller 72 into engagement with the outer circumference of cam 64. Thus, detent roller 72 will fall into one of the series of divots 66 when the divot 66 is proximate to detent roller 72. The force required to move handle 22 when detent roller 72 is engaged with a divot 66 establishes the detect torque required by a user to move the handle out of a particular predetermined detent position. An adjustment screw 78 is coupled to detent spring 76 and held in place in frame 16 by a nut 80. Adjustment screw 78 is manually adjustable to change the amount of force supplied by detent spring 76 to lever 70, thereby allowing for manual adjustment of the amount of detent torque required to move handle 18 out of a detent position.

Referring to FIG. 3, a disc 84 is fixedly mounted to outer plate 26 and includes a frictional surface 86 in engagement with cam 64. Frictional surface 86 is formed from a material that has a higher kinetic coefficient of friction than static coefficient of friction, such as DELRIN®AF, a PTFE fiber filled homopolymer acetal. Cam 64 is urged toward outer plate 26 into engagement with friction disc 84 by a spring assembly 88 that is positioned about shaft 28, such as via a bushing 90 through which shaft 28 extends and can rotate. Spring assembly 88 comprises a threaded spring cup hub 92 that is bolted to inner plate 54. Threaded hub 92 supports a correspondingly threaded hexagonal spring cup 94 that encloses an axial spring 96 that biases cam 64 toward friction disc 84 via a spacer 98 and accompanying set of thrust washers 100. Hexagonal spring cup 94 may be advanced axially over shaft 28 via rotation due to threaded engagement with hub 92 to increase or decrease the compression of spring 96, thereby increasing or decreasing the biasing force applied to cam 64 and the resulting frictional forces between cam 64 and disc 84.

The friction torque required to move handle 22 between detent positions is controlled by the coefficient of friction of friction surface 86 and the amount of force pressing cam 64 against friction surface 86. Thus, rotation of hexagonal spring cup 94 can change the friction toque by adjusting the amount of force being applied by spring 96. Similarly, detent torque may be adjusted using adjustment screw 78 to change the amount of force that spring 76 applied to lever 70 and thus the amount of force urging detent roller 72 against the peripheral edge of cam 64 and into any divot 66. As seen in FIG. 2, controller 10 may be provided with two handle assemblies 18 and 20, with each handle assembly 18 and 20 being independently adjustable to change friction torque and detent torque explained above.

The kinetic and static coefficient of friction of friction surface 86, in conjunction with the ratio of friction and detent torque, provide for smooth and controllable handle adjustments without any jerking or jumping when movement is initiated by a user. Adjustable controller 10 also avoids the need for railroads or owners of controller 10 to track which particularly components are needed in any controller 10 to achieve the desired handle feel as any controller 10 can be adjusted to meet the desired feel and repaired using the same components as any other controller 10. The design of controller 10 also improves the longevity of controller 10 as the torque generating interfaces, i.e., detent roller 74 and friction disk 84, are specifically designed for generating torque and thus are more robust that the conventional handle components that provide a given amount of torque simply because of their composition and design.

What is claimed is:

1. A brake controller having independently adjustable friction and detent torque, comprising:
a user handle rotatable into and between a series of predetermined positions;
a cam associated with the user handle for rotation therewith;
a first spring assembly providing a first biasing force resisting rotation of the cam; and
a second spring assembly providing a second biasing force resisting rotation of the cam.

2. The brake controller of claim 1, wherein the first spring assembly comprises a lever, a roller carried by the lever, and a first spring positioned to provide a first biasing force urging the roller into contact with the cam.

3. The brake controller of claim 2, wherein the cam includes an outer circumference having a series of divots corresponding to the series of predetermined positions into which the roller may extend when the handle is rotated.

4. The brake controller of claim 3, wherein the first spring assembly further comprises a screw associated with the first spring that may be rotated to increase or decrease compression of the first spring.

5. The brake controller of claim 1, wherein the second spring assembly comprises a second spring positioned to provide a second biasing force urging a lateral surface of the cam into a frictional surface.

6. The brake controller of claim 5, wherein the second spring assembly further comprises a spring cup that may be rotated to increase or decrease compression of the second spring.

7. A brake controller having independently adjustable friction and detent torque, comprising:
a user handle rotatable into and between a series of predetermined positions;
a cam interconnected to the user handle for rotation therewith and including an outer circumference and two opposing lateral surfaces;
a first spring assembly including a lever, a roller carried by the lever, and a first spring positioned to provide a first biasing force urging the roller against the outer circumference of the cam; and
a second spring assembly including a second spring positioned to provide a second biasing force urging the cam axially into a frictional surface that resists rotation of the cam.

8. The brake controller of claim 7, wherein the user handle and the cam are interconnected by a shaft.

9. The brake controller of claim 8, wherein the second spring is positioned about the shaft.

10. The brake controller of claim 9, wherein the frictional surface is on a disc positioned about the shaft between the handle and the cam.

11. The brake controller of claim 10, further comprising a screw that may be advanced toward or away from the lever to change the compression of the first spring and a spring cup that may be advanced or withdrawn along the shaft to change the compression of the second spring.

12. A method of independently adjusting the friction and detect torques of a brake controller, comprising the steps of:
changing the compression of a first spring that provides a first biasing force resisting the rotation of a cam that is interconnected to and rotatable with a user handle of the brake controller;
changing the compression of a second spring that provides a second biasing force resisting the rotation of the cam.

13. The method of claim 12, wherein the first spring is positioned to urge a roller into contact with an outer circumference of the cam.

14. The method of claim 13, wherein the second spring is positioned to urge a lateral side of the cam into contact with a frictional surface.
